(19) United States
(12) Patent Application Publication
(10) Pub. No.: US 2017/0011377 A1
(43) Pub. Date: Jan. 12, 2017

(54) Systems and Methods For Bifurcating Sales Proceeds and Transmitting Sales Taxes To Taxing Authorities In Near Real Time

(71) Applicant: Keith P. Stone, Scottsdale, AZ (US)

(72) Inventor: Keith P. Stone, Scottsdale, AZ (US)

(21) Appl. No.: 14/795,682

(22) Filed: Jul. 9, 2015

(51) Int. Cl. G06Q 20/20

(52) U.S. Cl. CPC G06Q 20/207; G06Q 20/204

(57) ABSTRACT

Systems and methods for bifurcating sales proceeds and transmitting sales taxes to a taxing authority include a point of sale (POS) terminal configured to assemble payment transaction data into a batch processing request including a sales price component and a sales tax component. The system also includes a primary payment processor configured to transmit first proceeds from the reconciliation of the sales price component to a merchant account, and a fiduciary payment processor configured to transmit second proceeds from the reconciliation of the sales tax component to a fiduciary account.

### TECHNICAL FIELD

The present invention generally relates to systems and methods for automatically remitting taxes to taxing authorities. More particularly, the following discussion relates to systems, methods and applications which facilitate the electronic accounting and payment of sales taxes in real time or near real time.

### BACKGROUND

Sales, use, excise, value added, and other taxes are routinely levied upon the sale of goods and services by federal, state, county, and municipal governments. Because a merchant must first collect sales tax from the purchaser before forwarding it to the taxing authority, most jurisdictions provide for a grace period between the time of purchase and the date the sales tax must be paid.

For example, sales taxes are typically due on the 25^{th} day of the month following the month in which the sale occurs; that is, sales tax liabilities incurred in January are payable February 25^{th}, and so on. Although this grace period provides a convenience to merchants, it also requires taxing authorities to wait between 25 and 55 days before receiving their sales tax revenue. Moreover, many companies go out of business or are otherwise unable to pay the sales taxes by the time they become due. In addition, the burden of manually preparing monthly sales tax reports imposed on merchants is substantial.

Presently known techniques for automating sales tax compliance include Avalara™ software products available at www.avalara.com. However, these approaches are cumbersome, time consuming, and do not address the delay between the time the tax is incurred and when it is received by the taxing authority. Systems and methods are thus needed which address these shortcomings.

### BRIEF SUMMARY

Various embodiments of the present invention relate to systems, devices and/or methods for partitioning sales revenue into a first component attributable to the sale of goods and/or services, and a second component attributable to the associated sales tax. A third party fiduciary segregates the sales tax component and transmits the sales tax revenue to the taxing authorities at the point of sale in real time or near real time.

Other embodiments provide systems and methods for monitoring and updating tax rates and payment protocols for a plurality of taxing districts, thereby offloading the task of tax reporting and payment from the merchant to the fiduciary.

Other embodiments provide systems and methods for organically determining an appropriate level of cash reserves to account for returns, breakage, and the like, both for an individual merchant and across industry sectors.

Other embodiments provide systems and methods for routing data and transmitting payments to taxing authorities using the geographically closest server or server cluster.

Other embodiments provide systems and methods for intercepting the sales tax component of reconciliation payments from a credit card processor to a merchant bank account, and diverting the sales taxes to a dedicated fiduciary account to be used for paying sales tax liabilities in real time or near real time. In this context, the term near real time contemplates periodic batch processing such as, for example, daily, nightly, weekly, or other periodic or non-periodic intervals.

Other embodiments provide systems and methods for coordinating sales tax payments to a plurality of different taxing districts and providing RSS feeds into a single, integrated code base.

Other embodiments provide systems and methods for updating currently deployed point of sale (POS) devices to implement the functionality described herein.

Other embodiments provide systems and methods for implementing the functionality described herein in the context of a mobile telephone, tablet computer, or other hand-held device.

Other embodiments provide systems and methods for allocating a portion of daily reconciliation proceeds from a credit card processor to a merchant for use in paying sales tax liability attributable to cash purchases in near real time.

Other embodiments provide systems and methods whereby a merchant authorizes a fiduciary to deduct proceeds from a merchant reconciliation account for use in paying sales tax liability attributable to cash sales in near real time.

Other embodiments provide systems and methods for allocating a portion of the proceeds from a merchant reconciliation account for use in paying sales tax liability in advance using a predictive model based on historical data.

Other embodiments provide systems and methods for estimating and paying sales tax liability in near real time using one or more of tax bracketing, tax holidays, tax preferred/enterprise zones, intrastate and interstate sales, on-line sales, “milk” programs whereby low certain consumers do not pay tax on designated essential items, EBT sales, equipment (e.g., airplane) leases, international and cruise line sales, coupon sales, gift cards, loyalty programs, and various metrics which ultimately impact a merchant's net sales tax liability.

Other embodiments contemplate implementing the functionality described herein on a mobile software application that can be downloaded to a mobile telephone or other hand-held or portable device to allow a retailer or merchant to submit taxes remotely from food truck, hot dog cart, road side vendor, or the like.

Various other embodiments, aspects and features are of the present invention are described in more detail below. Additional features and characteristics will become apparent from the subsequent detailed description and the appended claims, taken in conjunction with the accompanying drawings and this background section.

### BRIEF DESCRIPTION OF THE DRAWING FIGURES

Exemplary embodiments will hereinafter be described in conjunction with the following drawing figures, wherein like numerals denote like elements, and:

FIG. 1 is a schematic block diagram of an exemplary scheme for paying sales taxes in accordance with exemplary embodiments of the present invention;

FIG. 2 is a process flow diagram illustrating an exemplary sequence of steps for the payment scheme of FIG. 1 in accordance with exemplary embodiments of the present invention;

FIG. 3 is a schematic diagram further detailing various aspects of the fulfillment center shown in FIG. 1;

FIG. 4 is a schematic block diagram of an exemplary sales tax payment scheme in accordance with exemplary embodiments of the present invention;

FIG. 5 is a process flow diagram illustrating an exemplary sequence of steps for the payment scheme of FIG. 4 in accordance with exemplary embodiments of the present invention;

FIG. 6 is an alternate embodiment of an exemplary sales tax payment scheme in accordance with the present invention;

FIG. 7 is a flow diagram illustrating an exemplary process for determining the size of a return buffer in accordance with exemplary embodiments of the present invention;

FIG. 8 is a flow diagram illustrating an exemplary process for determining the magnitude of a cash reserve buffer in accordance with various embodiments of the present invention; and

FIG. 9 is a flow diagram illustrating an exemplary process for evaluating whether a merchant under reports, over reports, or misreports sales tax liability in accordance with various embodiments of the present invention.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

Various embodiments of the following discussion relate to protocols for processing credit, debit, and check card payments, and for allocating a portion of the proceeds otherwise deposited in a merchant's reconciliation account for use in paying sales tax liabilities in real (or near real) time.

As used herein, the term “consumer” include a person or entity (including a legal person such as a corporation) that purchases goods or services from a merchant. Similarly, the term “merchant” includes a person or entity that sells goods or services to a consumer regardless of whether the merchant has a “brick and mortar” presence, including on-line and e-commerce retailers, wholesalers, intermediary, consignment, and supply chain sellers and resellers, and service organizations and individuals.

The terms “credit card processor” and “processor” include an agent that performs back end processing and reconciliation on behalf of a merchant, often on a nightly batch processing basis. By way of non-limiting example, a processor typically performs nightly batch processing for a merchant's approved card based transactions for the preceding day. For example, a processor may electronically submit daily transaction data to a clearing house or fulfillment center, whereupon all Visa™ card transactions are sent to a Visa™ aggregator for subsequent processing, all Mastercard™ transactions are sent to a Mastercard™ aggregator for subsequent processing, and so on. Each aggregator fans out within their brand organization and retrieves funds from card holder accounts or from credit companies, and returns the aggregate funds to the processor. The processor then reconciles the authorized transactions by depositing funds in the merchant's bank account.

The term “fiduciary processor” is generally analogous to the aforementioned credit card processor or processor, and refers to an agent that performs back end processing and/or reconciliation for the all or a part of the sales tax portion of the card based transactions. The fiduciary processor can be the same entity as the processor, or may be a different entity working in concert with the processor.

The terms “merchant account” and “merchant bank account” refer to an account into which the processor deposits funds for the merchant's card based activity, and from which the processor withdraws funds to cover the processor's fees for performing the aforementioned transaction reconciliation services.

The term “fiduciary” includes a system, entity, and/or process (which could be implemented in computer code) that partitions a portion of the aforementioned reconciliation proceeds and uses them to pay sales tax liabilities to taxing authorities on behalf of a merchant.

The terms “debit” and “debit card” transaction refer to a card based purchase event in which a consumer uses a personal identification number (PIN) to facilitate the purchase, regardless of whether money is transferred from the consumer's account immediately or shortly thereafter. The terms “check card” and “checking” transaction refer to a card based purchase event in which the consumer does not use a PIN to facilitate the purchase, regardless of whether a “hold” is placed on the funds in the consumer's account immediately or shortly thereafter. The terms “credit card” and “credit” transaction refer to a card based purchase event in which a credit issuer extends credit to the consumer, and for which a bill or statement is rendered, regardless of whether a “hold” is placed on the funds in the consumer's account immediately or shortly thereafter. The term “card based” refers to an account arrangement between a consumer and a financial or credit institution (typically an issuing bank), regardless of whether a physical card is used to consummate the transaction.

The terms “credit company” and “credit issuer” include entities that issue debit cards and check cards, as well as credit cards which include a credit feature; that is, a feature which allows the card holder to purchase goods or services through the extension of credit. Typical credit companies include Visa™, MasterCard™, Discover™, Diners Club™, and the like.

The terms “issuing bank” and “card issuer” include a bank or other financial institution that issues a card instrument (with or without an accompanying physical card) for use by a consumer in completing card based purchase transactions. Typical issuing banks include Wells Fargo™, Bank of America™, Chase™ Bank, Melon™ Bank, and the like. In many instances, card instruments issued by issuing banks are co-branded to include the trademark of the issuing bank (e.g., Wells Fargo) as well as the trademark of the credit company (e.g., Visa) regardless of whether the card instrument functions as a debit card, credit card, and/or check card.

The term “taxing authority” includes any entity which levies taxes payable by a merchant, including global, federal (e.g., for gasoline and tobacco products), federal territories (such as Indian reservations) state, county, and municipal governments and taxing districts, as well as non-governmental and quasi-governmental authorities and organizations. Presently known arrangements among taxing authorities provide for a single authority (e.g., a state) to collect taxes from merchants on behalf of multiple taxing authorities (e.g., counties, cities) within that state, and to thereafter distribute the proceeds to the various participating authorities and districts.

The term “real time” refers to a narrow window of time which is substantially contemporaneous with an event, allowing for an inevitable but usually short delay associated with data transmission. The term “real time” processing is often used to distinguish from batch processing, wherein a plurality of events are accumulated and processed as a batch at the end of a block of time such as, for example, a day, week, hour, event or interrupt based, or other periodic or non-periodic scheme.

As used herein, the word “exemplary” means “serving as an example, instance, or illustration.” Any implementation described herein as “exemplary” is not necessarily to be construed as preferred or advantageous over other implementations, nor is it intended to be construed as a model that must be literally duplicated.

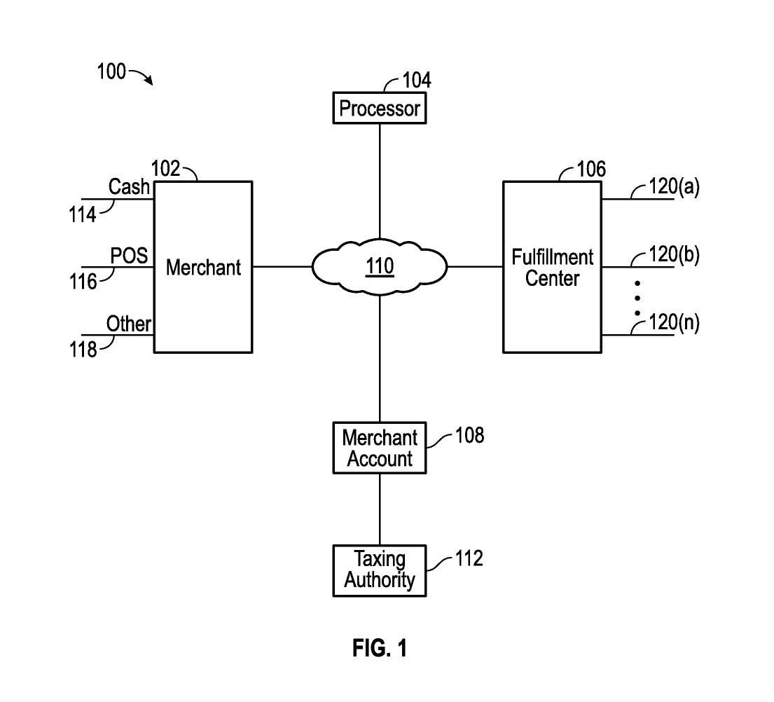

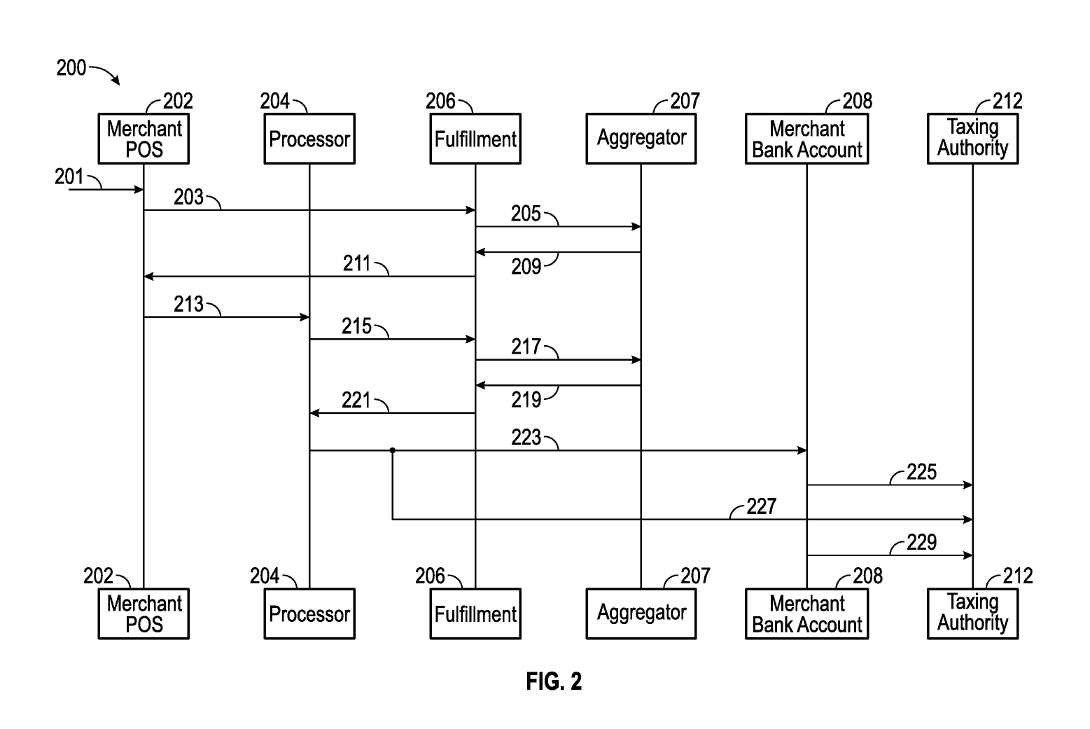

Turning now to the drawing figures, FIG. 1 is a schematic block diagram illustrating how a merchant pays sales taxes to a taxing authority in accordance with presently known methods. FIG. 2 is a process flow diagram illustrating the steps involved with the sales tax payment scheme shown in FIG. 1.

More particularly and referring now to FIG. 1, a sales tax payment system 100 includes a merchant 102, a processor 104, a fulfillment center 106, a merchant account 108, and a taxing authority 112. Some or all of the foregoing components may be configured to communicate with one another through a network no, such as a WAN, VPN, LAN or other private network, or a public network such as the internet. The merchant 102 may be configured to accept various forms of payment for goods and/or services, and may therefore be equipped with a cash register or cash drawer 114, a point of sale (POS) terminal 116, and other mechanism 118 configured to process coupons, gift cards, loyally points from a loyalty program, store credit, vouchers, or the like.

In an embodiment, the POS terminal 116 may comprise any suitable device configured to operate as a cash register or payment processing device such as may be available from Hypercom™, VeriFone™, AccuPOS™, Harbortouch™, POSGuys™, and Mercury™. The processor 104 may comprise a software and/or hardware module or system configured to implement the functions of a payment processor as described above. Alternatively, the functions of processor 104 may be performed by an enterprise service vendor such as, for example, PayPal.com, Tipalti.com, PaySimple.com, Transfirst.com, or Firstdata.com. As detailed below, many of the functions and features described herein may be implemented or facilitated by an improved processor in accordance with the present invention.

The fulfillment center 106 performs at least the following three basic functions: i) verifying that either sufficient funds or sufficient credit is available for a proposed purchase; ii) providing authorization to a merchant to thereby approve a purchase, typically by providing an electronic token to the merchant; and iii) batch processing (reconciling) purchases by retrieving funds either from the consumer's bank account (for debit or check card purchases) or from a credit company, and depositing the funds in the merchant's bank account during end-of-day reconciliation. As described in greater detail below, the fulfillment center 106 coordinates these functions by fanning out to various aggregators, banks, credit companies, and financial institutions via communication links 120.

Referring now to FIGS. 1 and 2, in a typical process 200 a consumer purchases goods and/or services from a merchant 202 using a credit, debit, or check card instrument facilitated by the merchant's POS terminal 116 (Task 201). The POS terminal is typically configured to determine the combined sales taxes payable to all applicable taxing authorities, and to calculate a total invoice amount which includes i) the underlying goods/services; and ii) the associated sales tax.

The merchant 202 (e.g., using POS terminal 116) sends a request for authorization to a fulfillment center 206 (Task 203), either directly or via a processor 204 affiliated with the merchant. The fulfillment center 206, in turn, interrogates the consumer's (card holder's) account or credit worthiness to verify that sufficient funds are available (Task 205), typically via an aggregator 207. If sufficient funds are available, the aggregator sends an authorization code (e.g., in the form of a token) to the fulfillment center (Task 209), whereupon the fulfillment center sends an authorization message to the merchant (Task 211) approving the transaction. If sufficient funds are not available, the card has been reported stolen, or the requested purchase is otherwise out of compliance (e.g., the card holder's daily purchase limit exceeded, the requested purchase is outside the card holder's profile, or the like), the purchase may be declined (Tasks 209, 211). Tasks 201-211 typically occur in real time, that is, over a period of several seconds. Tasks 201-211 are repeated throughout the day (or other batch processing window) for a plurality of card based purchases.

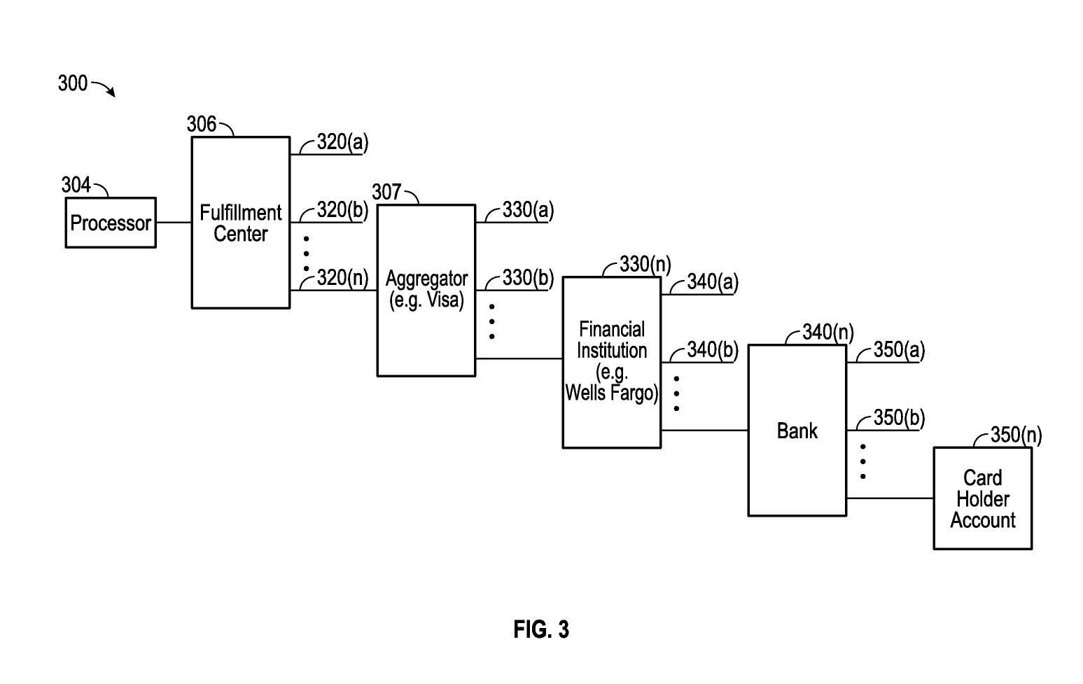

With continued reference to FIGS. 1 and 2, at the end of the day the POS terminal batch processes the day's purchases by sending a reconciliation request to the processor (Task 213). Alternatively, the processor 204 may be configured to poll the merchant's POS to retrieve the day's purchase data. The processor packages the card based purchase data and sends a reconciliation request (including tokens associated with authorized purchases, if applicable) to the fulfillment center 206 (Task 215). The fulfillment center, in turn, collects funds from credit sources and card holder accounts (Tasks 217, 219), as described in greater detail below in conjunction with FIG. 3.

The fulfillment center returns funds to the processor (Task 221) in response to the reconciliation request, whereupon the processor deposits the funds into the merchant's bank account 208 (Task 223). Notably, the deposited funds include a first portion corresponding to the respective sales prices for the underlying goods and services purchased, and a second portion corresponding to the applicable sales taxes. Depending on the particular contractual arrangement between a merchant and a processor, the processors fees payable by the merchant to the processor for performing card based payment processing may range from 0.5 to 5% or more of the purchase price. In some embodiments, the merchant authorizes the processor to debit the merchant's bank account to collect these fees on a periodic basis (e.g., monthly). In other embodiments, the processor may deduct (withhold) these fees from the daily deposits (as part of Task 223).

With momentary reference to FIG. 3, exemplary embodiments of the functions implemented by fulfillment center 206 and aggregator 207 (FIG. 1) and Tasks 20, 209, 217, and 219 (FIG. 2) are illustrated in greater detail. More particularly, a payment authorization and reconciliation system 300 includes a processor 304, a fulfillment center 306, one or more aggregators 307, one or more financial institutions (e.g., national banks, credit companies) 330, one or more local branches 340, and one or more card holder accounts 350. Those skilled in the art will appreciate that the system 300 may comprise alternative, additional and/or fewer components and their arrangement and interactions may vary, as desired. The basic functions performed system 300 are to authorize a sales transaction (typically in real time), and to thereafter reconcile a batch of transactions (typically in near real time).

With continued reference to FIG. 3, upon receiving a request for a purchase authorization (Task 203 in FIG. 2), the fulfillment center 306 routes the request to the appropriate one of a plurality of aggregators 307 along a communication link 320. By way of non-limiting illustration, aggregator 307 may correspond to Visa, MasterCard, American Express, or other credit card company that issues co-branded transaction cards with national banks. In the illustrated example, the aggregator 307 corresponds to the Visa International. After receiving the request for authorization, the aggregator 307 routes the request to the appropriate bank or other financial institution 330 such as, for example, Wells Fargo, Bank of America, Chase, or the like. In the illustrated example, the financial institution 330 corresponds to Wells Fargo Bank, which issues Visa co-branded credit cards.

After receiving the request for authorization, the bank 330 routes the request to the appropriate local branch, data center, or other source 340 which houses the bank or credit account information for the cord holder. The local bank 340 then interrogates the card holder account 350 to determine whether sufficient funds (or credit) are available to support the proposed purchase, whereupon a message (and token, if appropriate) is routed back to the merchant either authorizing or denying the proposed purchase (or prompting an additional action by the merchant or card holder).

With continued reference to FIG. 3, upon receiving a batch processing (e.g., an end-of-day) request to reconcile a plurality of payment transactions (Task 213 in FIG. 2), the fulfillment center 306 segregates the transactions into one or more sub-batches and routes each one to the appropriate aggregator 307. For example, all Visa branded transactions may routed to one or more Visa aggregators, the American Express branded transactions may routed to one or more American Express aggregators, and so on. Each aggregator then fans out to retrieve funds for the previously approved transactions from the appropriate card holder accounts and credit issuing entities, as appropriate. The funds are collected and routed back to the processor (Task 221 in FIG. 2), whereupon the processor deposits the funds into the merchant's bank account 208.

Returning now to FIGS. 1 and 2, Tasks 213-223 relate to the batch processing of card based purchase transactions and, as such, they typically occur in near real time; that is, over a period of several minutes, hours or days. Steps 213-223 are repeated each day, such that the deposits (Task 225) accumulate over the course of each month. As briefly mentioned above, sales taxes are typically payable by merchants to taxing authorities on a monthly basis, for example, on the 25^{th} day of each calendar month for the preceding month. Thus, in a typical use case, the merchant pays the previous month's sales tax liability from the merchant's bank account to the taxing authority or authorities (task 225) on the 25th day of the following month.

The foregoing payment scheme is disadvantageous in several respects. In particular, taxing authorities must wait between 25-55 days following a purchase to receive the applicable sales tax. The time value of this revenue is substantial. Moreover, many merchants encounter commercial and other difficulties between the time of a sale to a consumer and the date sales taxes are paid to the taxing authority, such that the merchant often lacks the funds with which to pay the sales tax liability when it is due and payable. In either case, the financial burden falls on the taxing authority, and ultimately to the citizens of that taxing authority. Various systems and methods for addressing these shortcomings will now be described.

With momentary reference to FIG. 2, the processor 224 may be configured to forward some of all of the estimated or actual sales tax liability to the taxing authority 212 on a near real time basis (Task 227). Alternatively, the system may be configured to transfer funds from the merchant account 208 to the taxing authority 212 on a near real time, periodic, or as needed basis (Task 229).

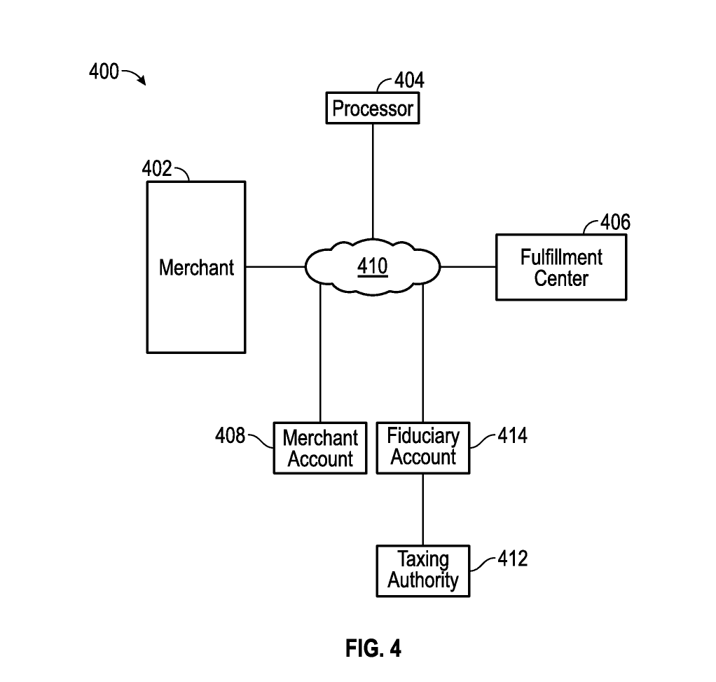

Referring now to FIG. 4, a sales tax payment system 400 in accordance with the present invention includes a merchant 402, a processor 404, a fulfillment center 406, a merchant account 408, a fiduciary account 414, and a taxing authority 412. Some or all of the foregoing components may be configured to communicate with one another through a network 410, such as the internet.

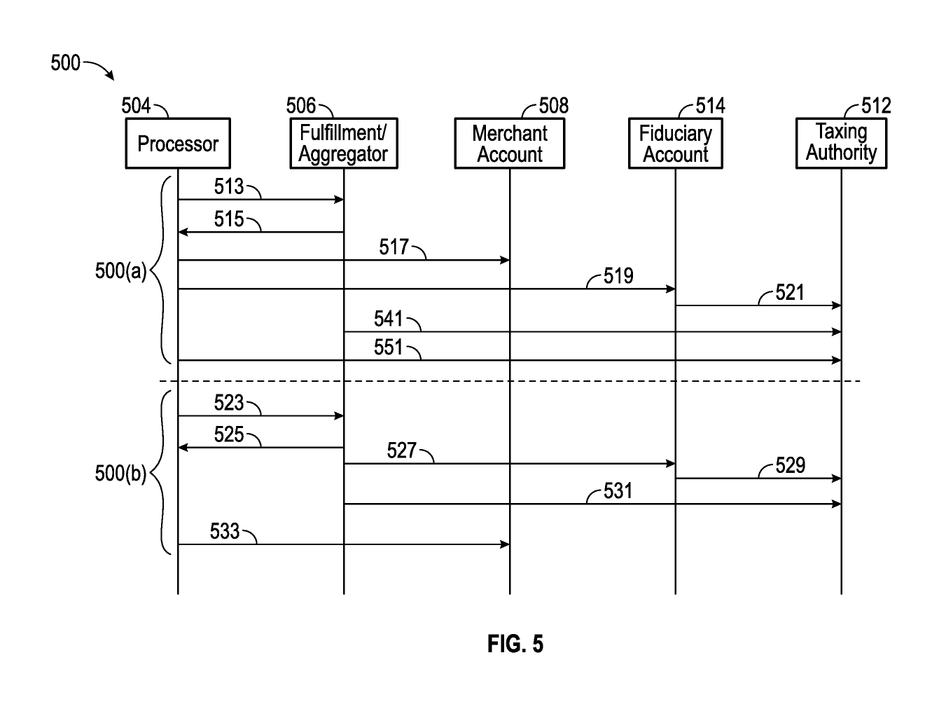

Turning now to FIG. 5 and with continued reference to FIG. 4, a reconciliation process 500(a) according to the present invention involves a processor 504 sending a reconciliation request (including tokens associated with authorized purchases, if applicable) (Task 513) to a clearing house 506 which may include a fulfillment center and one or more aggregators, credit companies, national banks, local banks, credit unions, consumer accounts, and the like. The fulfillment center, in turn, collects funds from credit sources and card holder accounts, for example, as generally described above in connection with FIG. 3.

The fulfillment center returns funds to the processor (Task 515) in response to the reconciliation request, wherein the funds may comprise a first portion corresponding to the purchase prices for the purchased goods and/or services, and a second portion corresponding to the associated sales taxes. The processor 504 then deposits the first portion of the funds into the merchant's bank account 508 (Task 517), and the second portion (the sales taxes) into the fiduciary account 514 (Task 519). Alternatively, the processor may be configured to deposit both the first and second portions into the merchant account, wherein the merchant pre-authorizes a fiduciary acting on the merchant's behalf to deduct funds from the merchant account in real time, near real time, intermittently, periodically, or at any time as appropriate to satisfy tax liability.

It can thus be seen that, in accordance with the present invention, sales tax revenue may be deposited into the fiduciary account in near real time (e.g., on a daily basis as a result of batch payment processing). Consequently, the fiduciary account may be configured to forward sales tax revenue to the taxing authority and/or authorities in near real time (Task 521). By way of non-limiting example, the fiduciary account may be configured to deposit funds into an account associated with the taxing authority on a daily (or other periodic) basis, or otherwise as requested (e.g., upon reaching a threshold amount of tax liability or a threshold amount of accumulated deposits in the fiduciary account).

In an alternate embodiment, the fulfillment canter 506 may be configured to forward sales tax proceeds directly to the taxing authority 512 (Task 541) or, as a further alternative, the processor 504 may be configured to forward sales tax proceeds directly to the taxing authority 512 (Task 551), with or without the presence of a fiduciary account.

With continued reference to FIG. 5, in an alternate embodiment, a reconciliation process 500 (b) involves a processor 504 sending a reconciliation request (Task 523) to a clearing house 506 which, in turn, collects funds from credit sources and card holder accounts as generally described above. In this alternate embodiment, the clearing house (fulfillment center) may return some of the funds (e.g., the first portion comprising the purchase prices of the underlying goods and/or services) to the processor (Task 525).

Moreover, in addition to or in lieu of transmitting reconciliation funds to the processor, the clearing house may also segregate the second portion of the reconciliation funds (corresponding to the sales tax liability) and deposit the second portion (some or all of it) directly into the fiduciary account 514 (Task 527), whereupon the fiduciary account may be configured to subsequently or substantially simultaneously forward the sales taxes to the taxing authority (Task 529). In yet a further embodiment, the clearing house may bypass the fiduciary account and deposit the sales taxes directly into directly with or at the direction of the taxing authority (Task 531). The processor may deposit the first portion of the funds into the merchant account 508 (Task 533), for example, as generally described above.

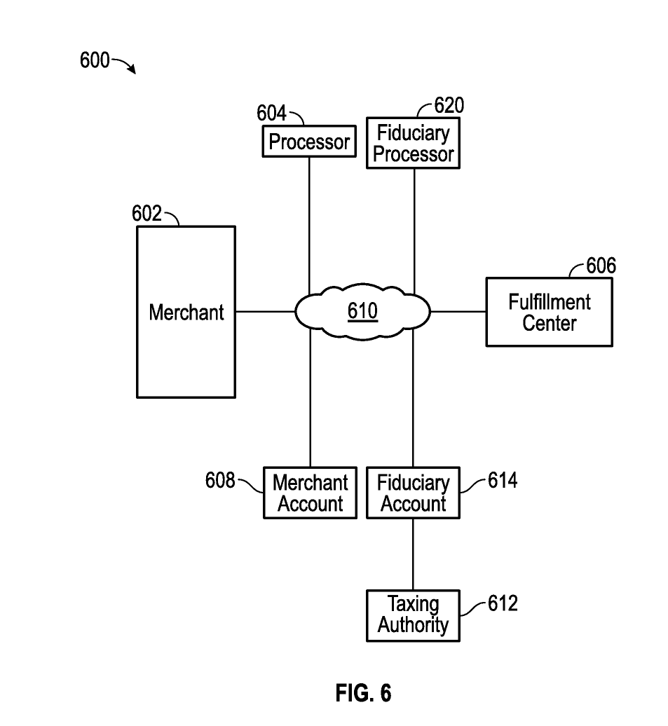

Referring now to FIG. 6, a sales tax payment system 600 in accordance with the present invention includes a merchant 602, a processor 604, an auxiliary or fiduciary processor 620, a fulfillment center 606, a merchant account 608, a fiduciary account 614, a taxing authority 612, and a communication network 610.

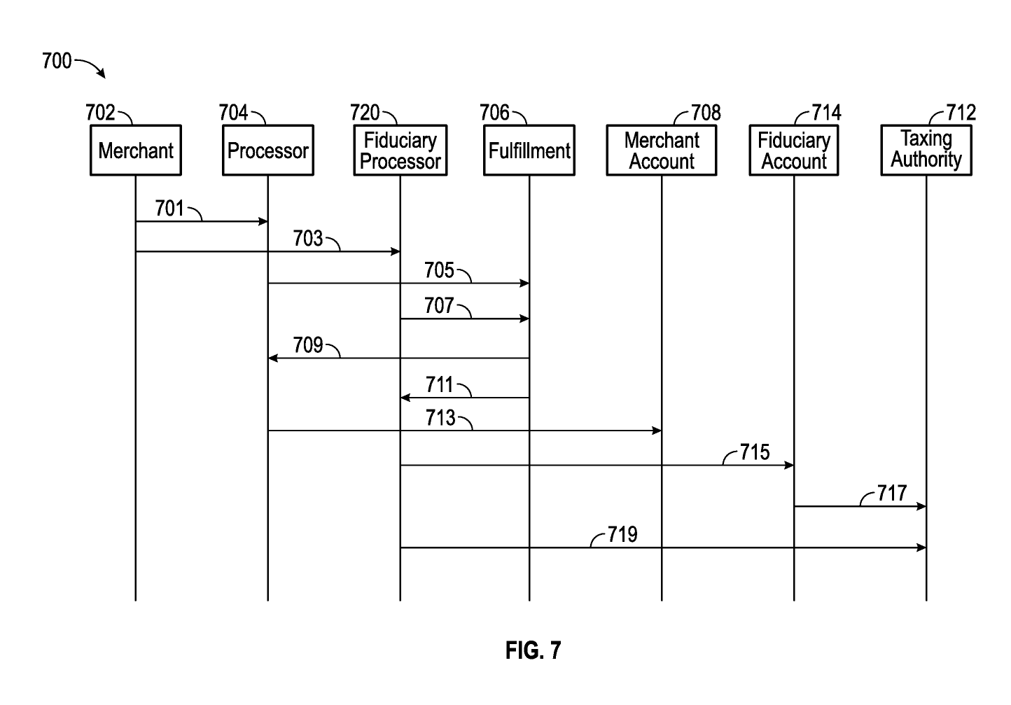

Turning now to FIG. 7 and with continued reference to FIG. 6, a reconciliation process 700 according to the present invention involves a merchant 702 sending a first reconciliation request (Task 701) to a traditional processor 704, and a second reconciliation request (Task 703) to a fiduciary processor 720. For example, the first reconciliation request may correspond to the purchase prices paid for the underlying goods and/or services, and the second reconciliation request may correspond to the associated sales taxes.

In an embodiment, the system may be configured to: i) process authorization requests for each proposed purchase (including both the sales price component and the sales tax component) via processor 704; or ii) process authorization requests for the sales price component via the processor 704, and separately process authorization requests for the sales tax component via the fiduciary processor 720. In either case, the processor 704 and the fiduciary processor 720 may be configured to process the authorization requests using some version of a fulfillment center 706.

In yet a further embodiment, the merchant 702 may be configured to transmit an end-of-day batch processing request to the processor 704, whereupon the processor 704 segregates the sales tax portion of the batch to be processed, and forwards the sales tax portion to the fiduciary processor 720 for parallel processing.

With continued reference to FIG. 7, processor 704 sends a first reconciliation request (Task 705) to the fulfillment center 706, and the fiduciary processor 720 sends a second reconciliation request (Task 707) to the fulfillment center 706. It will be appreciated that the first reconciliation request generally relates to the sales prices for the purchased goods and/or services. While the second reconciliation request generally relates to sales taxes associated with these purchases. The fulfillment center, in turn, collects funds from credit sources and card holder accounts, and returns funds responsive to the first reconciliation request to the processor 704 (Task 709), and returns funds responsive to the second reconciliation request to the fiduciary processor 720 (Task 711).

The processor 704 then deposits first funds into the merchant's bank account 708 (Task 713), and the fiduciary processor 720 deposits second funds into the fiduciary account 714 (Task 715), where the second funds correspond to the merchant's sales tax liability. The fiduciary account may then forward some or all of the sales tax funds to the taxing authority 712 (Task 717) on a daily basis or, alternatively, as defined by a set of rules (described in greater detail below).

In an alternative embodiment, the fiduciary processor 720 may be configured to deposit funds attributable to sales tax liability directly into an account associated with and/or at the direction of the taxing authority 712 (Task 719).

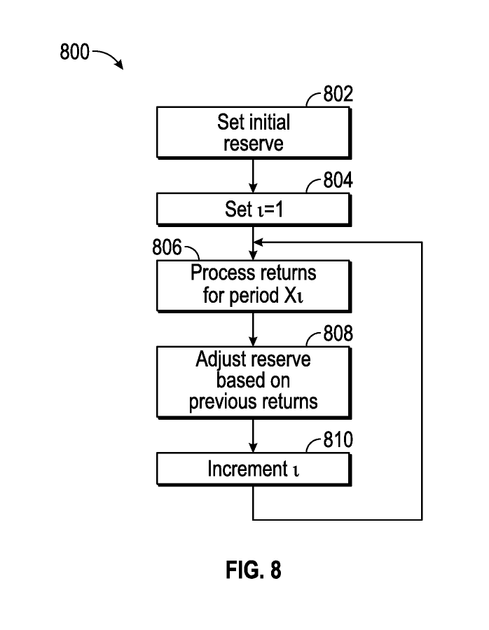

FIG. 8 is a flow diagram illustrating an exemplary process 80o for maintaining a cash reserve or “return” buffer, and for determining the magnitude of that buffer in accordance with various embodiments of the present invention. The present invention contemplates maintaining at least the following buffers: an individual buffer for a particular merchant; a sector buffer for each of a plurality of industry segments (e.g., pizza parlors, used car dealerships, drug stores); an aggregate buffer for all payments to a particular taxing authority or group of taxing authorities; and a fiduciary buffer for a particular fiduciary.

More particularly, those skilled in the art will appreciate that when a consumer returns goods to the merchant for a previous purchase, the processor typically credits the consumer's credit card (or debit or check card, as the case may be) immediately to account for the return. This credit includes a first portion attributable to the sales price, and a second portion attributable to the sales tax. Moreover, each merchant has a unique return policy and experience base. For example, one merchant may allow returns within thirty (30) days, while another may allow returns up to a year or more following the purchase.

Moreover, different retail sectors have different return trends as may be influenced by, for example, fluctuating interest rates, the Christmas Season, changes in weather, and the like. In any event, it is possible that the sales tax portion of a return may already have been paid to the taxing authority or otherwise segregated for that purpose at the time a return is processed in accordance with the present invention. In remains to determine how to reconcile crediting the sales tax (attributable to a return) to the consumer's credit card when the sales tax has already been paid to the taxing authority.

In an embodiment, a buffer account may be maintained in any suitable location such as, for example, at the processor, the fiduciary processor, the merchant account, the fiduciary account, or in a supplemental account associated with any one of the sales tax payment systems described herein. The buffer account may be configured to withhold a predetermined or variable amount of the sales tax liability otherwise payable to the taxing authority, to be used to fund the sales tax portion of a returned item or service (or when a purchase transaction is otherwise canceled or reversed).

By way of non-limiting example, an exemplary buffer (or “reserve”) account may be configured to grow organically as a function of or otherwise based on the return profile of a particular merchant. That is, if during a particular reporting period a merchant experiences a return rate of 15%, the system may withhold 15% of sales taxes otherwise payable to the taxing authority to account for anticipated returns. If the return rate actually experienced by the merchant increases or decreases during subsequent reporting periods, the percent withheld may be adjusted accordingly.

Alternatively, the buffer account may simply withhold a predetermined percent (e.g., between 1% and 20%) of total sales tax payments, whereupon the predetermined amount may be adjusted based on, for example, trends within the merchant's industry sector or other factors such as weather, seasonal variations, or historical tracking data.

By determining an appropriate return reserve for each merchant, a fiduciary processor, acting alone or in concert with a primary processor, may effectively estimate anticipated returns and account for the in advance. Thus, when a return is processed for which sales tax has already been paid to the taxing authority, the sales tax portion of the return may be debited from the reserve account and credited to the consumer's credit card in real time or near real time, as desired.

In an embodiment, a separate return account may be maintained for each merchant and/or industry sector. Alternatively, one or more aggregate reserve accounts may be maintained for a plurality of merchants and/or industry sectors. In yet a further embodiment, one or more reserve accounts may be maintained for each taxing authority or taxing authorities. In yet a further embodiment, one or more reserve accounts may be maintained for each processor, fiduciary processor, merchant account, and/or fiduciary account. Moreover, by using models employed by the industry, the funds comprising the reserve accounts may be invested, thereby earning a return for the fiduciary processor, which may be shared with the taxing authorities and/or merchants, if desired.

Returning now to FIG. 8, an exemplary process 800 includes setting an initial value for a reserve account (Task 802), and funding the reserve account with the initial value, if desired. In an embodiment, a counter may be set to an initial value, for example, i=1 (Task 804). Returns, breakage, voided and/or canceled transactions, and the like may be processed for any suitable period Xᵢ (e.g., daily, weekly, monthly, quarterly, annually, and the like) (Task 806). The then current reserve may then be adjusted as a function of (e.g., a weighted polynomial) or otherwise based on the experience base observed in one or more prior periods X (Task 808). A counter may be incremented (Task 810) at the end of a period, and the process repeated as needed to maintain an appropriate ongoing reserve balance.

In accordance with a further embodiment, taxing authorities may be incented to adopt a system whereby merchants remit sales tax liabilities on a near real time basis. For example, a fiduciary processor may offer to pre-pay a portion of sales tax liability in advance on a daily, weekly, monthly, quarterly, or annual basis based on predictive models using some form of the algorithm described in connection with FIG. 8. In one embodiment, the fiduciary processor or manager of a fiduciary account could pre-pay a taxing authority a variable percentage of tax proceeds as determined by the then current estimate of the next month's tax revenue.

Those skilled in the art will also appreciate that merchants sometimes under-report sales tax liabilities, for example by failing to report a portion of cash sales. In an embodiment, by using the techniques described above in connection with FIG. 8, the system can reliably estimate the percentage of total sales which are likely attributable to cash sales, and render a tax bill accordingly. For example, if aggregate data suggests that a particular industry sector (e.g., used car sales) is characterized by a credit sales over cash sales ratio of 3:1, but a particular merchant in that sector reports a ratio of 5:1, the system may reliably predict that the merchant is understating cash sales.

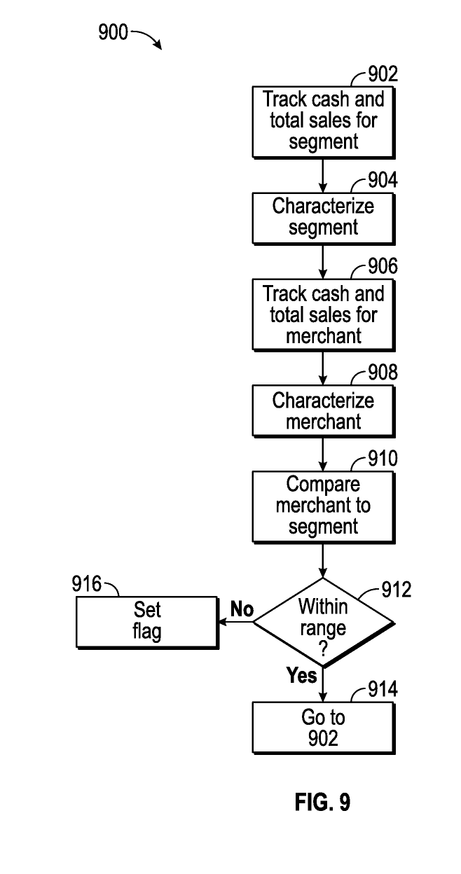

FIG. 9 is a flow diagram illustrating an exemplary process 900 for evaluating whether a merchant under reports, over reports, or misreports sales tax liability in accordance with various embodiments of the present invention. The method 900 includes tracking cash sales, non-cash sales, and any other metrics for an industry or geographic segment (e.g., zip code) over a period of time P (Task 902). The data collected may then be characterized (Task 904) for that industry segment in any suitable manner, such as the ratio of non-cash sales to cash sales.

With continued reference to FIG. 9, the process 900 further involves tracking cash sales, non-cash sales, and any other metrics for a particular merchant or group of merchant's within the industry segment over the same period P (Task 906), and characterizing the data for that merchant (Task 908). The characterization of the merchant under scrutiny may then be compared to the characterization for the industry segment (Task 916). If the comparison is within an acceptable range (“Yes” branch from Task 912), some or all of steps 902-916 may be repeated (Task 914). If, on the other hand, the comparison is outside of a predetermined or acceptable threshold (“No” branch from Task 912), a flag may be set (Task 916). The flag may be used to trigger any suitable action such as, for example, determining imputed tax liability for a merchant deemed to have under-reported cash sales during period P.

In an embodiment, one or more of the functions or features described herein may be implemented as a cloud-based and/or software as a service (SAS) model, where the server or server cluster may reside on any one or more of the components shown or described in the figures.

Alternatively, software and/or firmware for implementing the functionality described herein may be disposed in a mobile phone, tablet computer, IPad, laptop, desktop, kiosk, cash register, POS, or any other portable or hand held device. In this regard, the system may also contemplate rich site summary (RSS) feeds or other techniques for providing up to date information for changing tax rates, due dates, and protocols for any number of taxing authorities. In addition, the system could also contemplate tax bracketing, tax holidays, tax preferred/enterprise zones, intrastate and interstate sales, on-line sales, “milk” programs whereby low income or other demographic groups are not subject to sales taxes on certain goods or services essentials, EBT sales, coupon sales, gift cards, loyalty programs, and different metrics which ultimately impact total sales tax liability.

Although the foregoing description is set forth in the context of card based transactions, it will be appreciated that cash and other non-card based transactions such as, for example, barter transactions, loyalty programs, rewards programs, rebate, lease (e.g., vehicle and equipment leasing), and installment plans, or any other commercial transaction which triggers tax liability, are also contemplated. For example, to account for any transaction for which a tax is payable, the processor (or fiduciary processor) could withhold a portion of the proceeds that would otherwise be deposited into the merchant account, and use that portion to pay sales taxes attributable to cash sales in real time or, alternatively, near real time. In yet a further embodiment, the system may be configured to deduct funds from a merchant or other account to pay sales tax liability as and when the tax becomes due, independent of whether sufficient reconciliation funds have previously accumulated.

In accordance with various embodiments, the merchant may comprise a web site or e-commerce platform, such that the POS terminal or other payment device is remote from and electronically accessible by the card holder.

An improved system is thus provided for processing credit card payments. In particular, the system which is improved is of the type which includes: a merchant point of sale (POS) terminal configured to record card based payment transactions and assemble them into a batch processing request; a processor configured to receive the batch processing request from the POS and facilitate reconciliation of the batch processing request; and a merchant account configured to receive, from the processor, proceeds resulting from the reconciliation. In an embodiment, the improvement involves configuring the processor to: i) bifurcate the reconciliation proceeds into a sales price component of the card based payment transactions and a sales tax component of the card based payment transactions; and ii) transmit the sales price component to the merchant account.2. The system of claim 1, the improvement further comprising providing a fiduciary account.

In an embodiment, the improvement further comprises configuring the processor to transmit the sales tax component to the fiduciary account.

In an embodiment, the processor is configured to transmit the sales tax component to the fiduciary account in near real time relative to the POS recording the card based payment transactions.

In an embodiment, the improvement further involves configuring the processor to facilitate transmitting the sales tax component to a taxing authority in near real time.

In an embodiment, near real time is in the range of about 12 to about 72 hours, and preferably about 24 hours.

In an embodiment, the improvement further comprises providing a fiduciary account, and wherein the processor is configured to transmit the sales tax component to the fiduciary account in near real time, and further wherein the fiduciary account is configured to thereafter transmit at least a portion of the sales tax component to the taxing authority.

In an embodiment, the improvement further involves providing a return buffer, wherein at least a portion of the sales tax component is maintained in the return buffer.

In an embodiment, the return buffer comprises at least one of: an individual buffer for the particular merchant; an industry sector buffer; an aggregate buffer for the taxing authority; and a fiduciary buffer for a fiduciary account.

In an embodiment, the return buffer is based on a return profile of the merchant.

In an embodiment, the return buffer is maintained by: setting an initial value for the return buffer; monitoring returns for the merchant; and adjusting the value of the return buffer based on the monitored returns.

In an embodiment, the improvement further includes: recording the merchant's cash based payment transactions over a period P; comparing the merchant's cash based transactions over the period P to cash based transactions for an industry segment over the period P; and determining, based on the comparison, if the merchant's cash based transactions exceed a threshold value.

In an embodiment, the improvement further involves calculating an imputed sales tax liability attributable to the merchant's cash sales based on the determining step.

A sales tax processing system is thus provided which includes: a point of sale (POS) terminal configured to assemble payment transaction data into a batch processing request including a sales price component and a sales tax component; a primary payment processor configured to transmit first proceeds from the reconciliation of the sales price component to a merchant account; and a fiduciary payment processor configured to transmit second proceeds from the reconciliation of the sales tax component to a fiduciary account.

In an embodiment, the fiduciary account is configured to transmit at least a portion of the second proceeds to a taxing authority in near real time.

In a further embodiment the fiduciary account comprises a taxing authority.

In an embodiment, the primary payment processor and the fiduciary payment processor are configured to cooperate with a fulfillment center to effect reconciliation.

A method of transmitting sales taxes to a taxing authority is further provided, the method being of the type including the steps of: assembling a plurality of card based payment transactions into a batch processing request; transmitting the batch processing request to a payment processor; and reconciling the batch processing request into proceeds. In an embodiment, the improvement involves: segregating the proceeds into a first portion comprising sales price proceeds and a second portion comprising sales tax proceeds; transmitting the first portion to a merchant account; and transmitting the second portion to a fiduciary account.

In an embodiment, transmitting the second portion to a fiduciary account occurs in near real time relative to reconciling the batch processing request into proceeds.

In an embodiment, the method further includes transmitting at least part of the second portion from the fiduciary account to a taxing authority in near real time.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed:

1. In a system for processing credit card payments of the type including:
a merchant point of sale (POS) terminal configured to record card based payment transactions and assemble them into a batch processing request;
a processor configured to receive the batch processing request from the POS and facilitate reconciliation of the batch processing request; and
a merchant account configured to receive, from the processor, proceeds resulting from the reconciliation;
the improvement comprising configuring the processor to:
i) bifurcate the reconciliation proceeds into a sales price component of the card based payment transactions and a sales tax component of the card based payment transactions; and
ii) transmit the sales price component to the merchant account.

2. The system of claim 1, the improvement further comprising providing a fiduciary account.

3. The system of claim 2, the improvement further comprising configuring the processor to transmit the sales tax component to the fiduciary account.

4. The system of claim 3, wherein the processor is configured to transmit the sales tax component to the fiduciary account in near real time relative to the POS recording the card based payment transactions.

5. The system of claim 1, the improvement further comprising configuring the processor to facilitate transmitting the sales tax component to a taxing authority in near real time.

6. The system of claim 5, wherein near real time is in the range of about 12 to about 72 hours.

6. (canceled)

7. The system of claim 5, wherein the improvement further comprises providing a fiduciary account, and wherein the processor is configured to transmit the sales tax component to the fiduciary account in near real time, and further wherein the fiduciary account is configured to thereafter transmit at least a portion of the sales tax component to the taxing authority.

8. The system of claim 1, the improvement further comprising providing a return buffer, wherein at least a portion of the sales tax component is maintained in the return buffer.

9. The system of claim 8, wherein the return buffer comprises at least one of:
an individual buffer for the particular merchant;
an industry sector buffer;
an aggregate buffer for the taxing authority; and
a fiduciary buffer for a fiduciary account.

10. The system of claim 8, wherein the return buffer is based on a return profile of the merchant.

11. The system of claim 8, wherein the return buffer is maintained by:
setting an initial value for the return buffer;
monitoring returns for the merchant; and
adjusting the value of the return buffer based on the monitored returns.

12. The system of claim 11, the improvement further comprising:
recording the merchant's cash based payment transactions over a period P;
comparing the merchant's cash based transactions over the period P to cash based transactions for an industry segment over the period P; and
determining, based on the comparison, if the merchant's cash based transactions exceed a threshold value.

13. The system of claim 12, the improvement further comprising calculating an imputed sales tax liability attributable to the merchant's cash sales based on the determining step.

14. A sales tax processing system, comprising:
a point of sale (POS) terminal configured to assemble payment transaction data into a batch processing request including a sales price component and a sales tax component;
a primary payment processor configured to transmit first proceeds from the reconciliation of the sales price component to a merchant account; and
a fiduciary payment processor configured to transmit second proceeds from the reconciliation of the sales tax component to a fiduciary account.

15. The system of claim 14, wherein the fiduciary account is configured to transmit at least a portion of the second proceeds to a taxing authority in near real time.

16. The system of claim 15, wherein the fiduciary account comprises a taxing authority.

17. The system of claim 14, wherein the primary payment processor and the fiduciary payment processor are configured to cooperate with a fulfillment center to effect reconciliation.

18. In a method of transmitting sales taxes to a taxing authority of the type including the steps of: assembling a plurality of card based payment transactions into a batch processing request; transmitting the batch processing request to a payment processor; and reconciling the batch processing request into proceeds;
the improvement comprising:
segregating the proceeds into a first portion comprising sales price proceeds and a second portion comprising sales tax proceeds;
transmitting the first portion to a merchant account; and
transmitting the second portion to a fiduciary account.

19. The method of claim 18 wherein transmitting the second portion to a fiduciary account occurs in near real time relative to reconciling the batch processing request into proceeds.

20. The method of claim 18, further comprising transmitting at least part of the second portion from the fiduciary account to a taxing authority in near real time.
